(19) United States
(12) Patent Application Publication
(10) Pub. No.: US 2024/0195238 A1
(43) Pub. Date: Jun. 13, 2024

(54) COOLING ARRANGEMENT FOR COOLING A STATOR FOR AN ELECTRIC MOTOR

(71) Applicant: ZF Friedrichshafen AG, Friedrichshafen (DE)

(72) Inventors: Martin Christians, Friedrichshafen (DE); Rayk Gersten, Friedrichshafen (DE); Marcel Schmitt, München (DE); Wolfgang Hübler, Wolpertswende (DE)

(73) Assignee: ZF Friedrichshafen AG, Friedrichshafen (DE)

(21) Appl. No.: 18/531,790

(22) Filed: Dec. 7, 2023

(30) Foreign Application Priority Data
Dec. 7, 2022 (DE) 10 2022 213 189.4

(51) Int. Cl. H02K 1/20

(52) U.S. Cl. CPC H02K 1/20

(57) ABSTRACT

The invention relates to a cooling arrangement (1, 1a) for cooling a stator (2) of an electric machine having a housing (10) and a stator (2), which is arranged fixed about a rotation axis in the housing (10), where the rotation axis defines an axial direction and a radial direction radially relative to the rotation axis. At the respective axial ends of the stator (2) a first cooling fluid ring (8, 8a) is mounted to form a first ring-shaped annular space with the housing (10) and a second cooling fluid ring (9) is mounted to form a second ring-shaped annular space, each of them designed to convey cooling fluid.

### RELATED APPLICATIONS

This application claims the benefit of and right of priority under 35 U.S.C. § 119 to German Patent Application no. 10 2022 213 189.4, filed on 7 Dec. 2022, the contents of which are incorporated herein by reference in its entirety.

### FIELD OF THE DISCLOSURE

The invention relates to a cooling arrangement for cooling a stator of an electric machine that comprises a housing and a stator fixedly arranged about a rotation axis in the housing, wherein the rotation axis defines an axial direction and, radially relative to the rotation axis, a radial direction, wherein at respective ends on the stator a first cooling fluid ring is mounted in order to form a first annular ring space with the housing and a second cooling fluid ring is mounted in order to form a second annular ring space, each of these being designed to convey a cooling fluid.

### BACKGROUND

Electric machines, which comprise a rotor and a stator surrounding the rotor, nowadays have to satisfy strict requirements. The electric machines, particularly those in motor vehicles, have to sustain large torques in a very small structural space. This results in a high current density in the windings of the rotor and stator, leading to thermal losses and a substantial amount of waste heat. However, that can affect the performance of the electric machine.

To reduce the waste heat from the electric machine, the rotor and the stator are cooled. For this, for the stator in particular air or water are used. For example, the stator can be cooled by a water jacket on the outside. However, that takes up a lot of fitting space.

DE 10 2009 034 235 A1 discloses a stator of a hybrid or electric vehicle with a plurality of essentially annular stator segments, whose axes are directed essentially radially, with a cooling device for cooling the stator. The cooling device has ribs formed in the stator segments, such that the ribs form cooling ducts, such that the stator has a stator support, and such that the stator segments and the stator support are orientated relative to one another, and the stator support is designed in such manner that the cooling device is delimited by the stator support.

DE 102012022452A1 discloses an electric machine, in particular for a drive-train of a motor vehicle, having a machine housing with a stator positionally fixed relative to the machine housing, with a rotor mounted so that it can rotate relative to the machine housing, and with a cooling arrangement comprising at least one cooling duct which is arranged in the area of an outer periphery of the stator and through which a cooling fluid can be passed.

### SUMMARY

A purpose of the present invention is to indicate a cooling arrangement that enables better cooling for an electric machine.

This objective is achieved by a cooling arrangement with the features specified in the present disclosure. Advantageous further developments, which can be used in isolation or in combination with one another, are indicated in the claims and in the description.

The objective is achieved by a cooling arrangement for cooling a stator of an electric machine which comprises a housing and a stator fixedly arranged about a rotation axis in the housing, such that the rotation axis defines an axial direction and, radially relative to the rotation axis, a radial direction, wherein axially at the respective ends of the stator a first cooling fluid ring is mounted to form a first annular ring space with the housing and a second cooling fluid ring is mounted to form a second annular ring space, which are each designed to convey a cooling fluid.

The first cooling fluid ring has on the stator side a first annular groove with a first diameter, which with the housing forms a first annular chamber, such that the first annular chamber has at least one cooling fluid inlet for letting in a cooling fluid and such that the first annular chamber is sealed on the stator side with a first all-round seal, and such that the first annular chamber has outlets for letting out the fluid in the stator, whereas the cooling fluid can at least in part be deflected into the stator as a backwash fluid.

The cooling fluid ring comprises at least one second annular groove with a second diameter, which with the housing forms at least one second annular chamber, wherein the second annular groove faces away from the stator side and is arranged axially close to the first annular groove, the second annular chamber is sealed relative to the housing by a second all-round seal, wherein in the direction of the stator the second annular chamber has axial inlets, wherein the second diameter is smaller than the first diameter so that in the radial direction underneath the first annular chamber axial perforations can be formed, which perforations in the axial direction open into the axial inlets of the second annular chamber in order to let the deflected backwash fluid into the second annular chamber, wherein between the first annular chamber and the second annular chamber a third all-round seal supported against the housing is arranged in order to seal the first annular chamber relative to the second annular chamber.

The two cooling fluid rings can be centered or orientated relative to the stator yoke and stator tubes arranged on the stator.

By means of such a two-part first cooling fluid ring with two annular chambers, better cooling can be achieved. Moreover, by virtue of the arrangement of a first annular duct and a second annular duct with different diameters the first cooling fluid ring can be made in one piece. This on the one hand requires fewer seals, and on the other hand simplifies assembly.

Furthermore, with this cooling arrangement an optimum two-stream cooling can be achieved without having to provide or modify axial or radial fitting space. The design of surrounding components can therefore remain the same. Thus, all of the flow can be used for cooling the stator and the backwashed cooling fluid can be used for cooling a first winding head. In particular, by bringing in the fluid from only one end side of the stator yoke, the existing fitting space can be used optimally.

In a further design, first stator axial ducts in the stator are distributed in the axial direction around a periphery of the stator, and close to the first stator axial ducts second stator axial ducts are arranged, such that deflection ducts are formed in or on the second annular space in order to deflect the cooling fluid flowing through the first stator axial ducts and the corresponding outlets into the second, adjacent stator axial ducts as the backwash fluid, and such that the second stator axial ducts open into the axial perforations so that the backwash fluid flows through the axial perforations and through the axial inlets into the second annular chamber of the first cooling fluid ring and the housing, whereas third stator axial ducts are provided close to the second stator axial ducts for leading the cooling fluid from the first annular space into the second annular space of the second cooling fluid ring.

In this case the stator axial ducts can be distributed uniformly around the circumference and can be in the form of bores in the stator yoke. In that way a second winding head can be cooled from the second annular space by a cooling fluid such as oil.

Thus, fluid is transferred to the second cooling fluid ring, in this case on the connecting side, by way of the third stator axial ducts. Moreover, the first winding head can be supplied with the backwash fluid flowing through the second stator axial ducts.

Such bores in the stator, with corresponding deflection ducts, enable simple but targeted cooling fluid guiding.

In a further design the first, second, and third stator axial ducts can be distributed uniformly around a periphery of the stator, so that half of the cooling fluid flows in the second annular space and half of it flows, as the backwash fluid, back into the second annular chamber of the first annular space, i.e., two-thirds of the stator axial ducts supply the non-connecting side and one-third of the stator axial ducts supply the connecting side with cooling fluid, preferably oil. In this case the second annular space can have radial slots (not shown) for letting out the oil flowing through the third stator axial ducts into the second annular space toward the second winding head, so that it is cooled sufficiently.

In a further design, screens are arranged between the first annular groove and the third stator axial ducts on the first annular groove, by which an adjustment of the cooling fluid flowing in the third stator axial ducts can be carried out. In this case the first annular groove is arranged with the screens, in particular adhesively bonded, at the end side of the stator.

In a further design the screens are arranged above the third stator axial ducts on the first annular groove, in such manner that a cooling fluid flowing through a corresponding outlet between the screens flows through and the screens form a volume flow barrier. By virtue of the screens, the volume flow of the first stator axial ducts and the third stator axial ducts can be influenced in such manner that the oil spray quantity on the connection side (second cooling fluid ring) and the non-connection side (first cooling fluid ring) can be adjusted.

Furthermore, the stator can have a stator winding laid in stator grooves, wherein the number of stator axial ducts is equal to the number of stator grooves. This enables adequate cooling of the stator.

Stator grooves can be formed by stator teeth arranged on the stator yoke, which are arranged a distance apart in the radial direction.

In a further design the stator has at its end, at least partially, a first winding head arranged in the radial direction under the first annular space and, at least partially, a second winding head arranged in the radial direction under the second annular space, and the second annular groove comprises at least one radial slot as an outlet for the backwash fluid toward the first winding head.

In this case the first slot can be arranged on a radial upper side of the second annular groove and two further slots can be arranged each close to the first slot as outlets for the backwash fluid in the direction toward the first winding head. Moreover, the first radial slots can be arranged in the area of a 12 o'clock position and in the area of a 10 o'clock position and in the area of a 2 o'clock position of the second annular groove. In that way, oil can drizzle down onto the first winding head.

In a further design the first seal and also the second seal and the third seal are in each case in the form of sealing lips, and each has a larger radial length than the radial length between the first annular chamber or the second annular chamber and the housing, so that the first sealing lip and also the second sealing lip and the third sealing lip are held against the housing by the action of pressure. Thanks to the larger radial design of the sealing lips, during assembly the entire first cooling fluid ring can be pushed as a unit into the housing, whereby the seals are pressed against the housing and so form a seal. By virtue of the said pressure a pressure-activated sealing effect against the housing is also ensured and the sealing action is improved. By virtue of an integral design, the “pushing in” of the entire first cooling fluid ring during assembly in the housing can be done particularly simply.

In this case the first all-round sealing lip can be arranged on the stator side on a first annular groove wall of the first annular groove of the first annular chamber, extending in the direction of the housing; the third sealing lip is arranged opposite the first sealing lip on the first annular groove, radially in the direction of the housing and extending toward a third annular groove wall, and the second sealing lip is arranged on the housing side on the second annular groove of the second annular chamber, radially in the direction toward the housing and extending toward a second annular groove wall. The first annular groove wall can have a larger diameter than the third annular groove wall and the third annular groove wall can have a larger diameter than the second annular groove wall.

Moreover, the first sealing lip can be injection-molded onto the first annular groove and the second sealing lip onto the first annular groove and the third sealing lip onto the second annular groove, or onto the corresponding annular groove walls.

In a further design the first annular groove and the second annular groove are made as the first component of a two-component injection-molded part, whereas the first sealing lip, the second sealing lip, and the third sealing lip are made as the second component of the two-component injection-molded part, so that an integral production of the first cooling ring with the seals is enabled.

This design is particularly simple to produce.

Alternatively, the second sealing lip can be injection-molded onto the first annular groove and the third sealing lip onto the second annular groove, such that the first annular groove can be designed for separate fitting of the first sealing lip.

In a further design, the second all-round seal is formed from a second seal base and second sealing tubes projecting at the sides in the radial direction, so that the second seal is arranged with the second seal base on the second annular groove, and the second annular groove comprises second lateral contact elements which are formed by the second annular groove itself and by the housing, and the second sealing tubes make pressure-activated contact with the second lateral contact elements so that a pressure-activated sealing effect relative to the housing is produced.

The third all-round seal is formed from a third seal base and third sealing tubes projecting at the sides in the radial direction, such that the third seal with the third seal base is arranged on the first annular groove, and such that the first annular groove has lateral third contact elements, which are formed by the first annular groove itself and also by the housing, and such that the third sealing tubes make pressure-activated contact with the third lateral contact elements, so that a pressure-activated sealing effect relative to the second annular chamber is produced.

The first all-round seal is formed from a first seal base and first sealing tubes projecting at the sides in the radial direction, and wherein the first seal base is arranged on the housing and the first annular groove comprises a contact wall and the housing as a first lateral contact element, and wherein the first sealing tubes make pressure-activated contact with the first lateral contact elements, so that a pressure-activated sealing effect relative to the stator is produced.

In a further design the first all-round seal is pre-fitted in the housing, and the first seal base has a metal inlay which ensures better adhesion of the first seal base to the housing. This can ensure simplified assembly.

### BRIEF DESCRIPTION OF THE DRAWINGS

Further features and advantages of the present invention emerge from the following description, with reference to the attached figures which show, in a schematic manner:

FIG. 1: the overall system of the cooling arrangement according to the invention;

FIG. 2: a first cooling fluid ring, in detail:

FIG. 3: an oil inlet, in detail:

FIG. 4: the stator axial ducts, in detail;

FIG. 5: axial inlets, in detail:

FIG. 6: axial perforations and the axial inlets in operation:

FIG. 7: a screen, in detail:

FIG. 8: a further cooling arrangement with a further cooling fluid ring;

FIG. 9: the first seal arranged in the housing, with the first seal base and the first sealing tubes; and

FIG. 10: cooling arrangement in operation.

### DETAILED DESCRIPTION

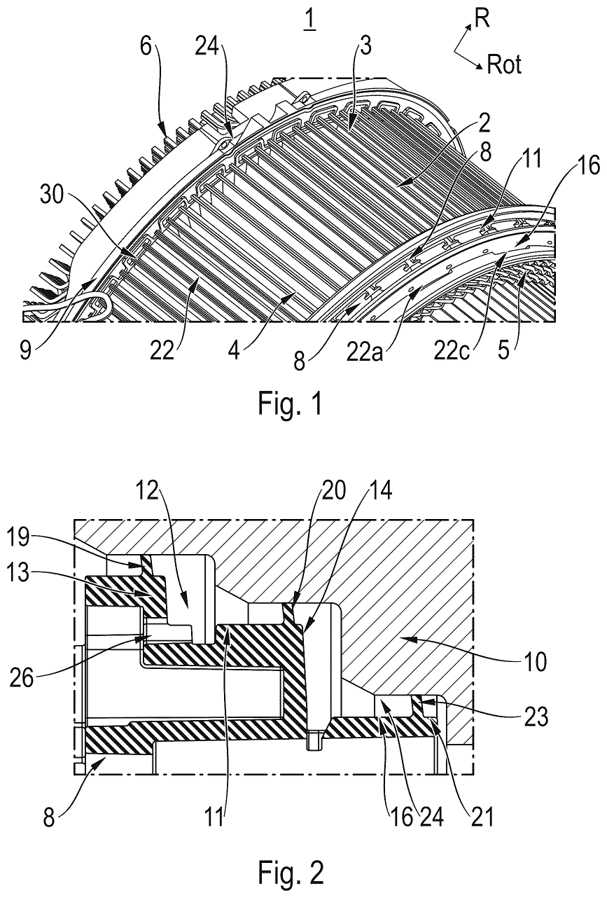

FIG. 1 shows the overall system of the arrangement 1, according to the invention.

The cooling arrangement 1, according to the invention, comprises a stator 2 which is mounted around a rotation axis Rot in a housing 10. The stator has a stator yoke 3, which extends in a radial direction R around the rotation axis Rot. Here, the axial direction A is understood to be a direction parallel to and along the rotation axis Rot. The radial direction extends in the direction of the radii of the stator 2.

The stator has stator grooves 4, which stator grooves 4 extend in the axial direction. In the stator grooves is arranged a winding which at each end, also called the face sides, form a first winding head 5 (only indicated) and a second winding head 6 (only indicated). Moreover, the stator 2 can also have stator teeth, which are not shown here.

The stator 2 is partially surrounded by a stator housing. Moreover, the stator 2 is cooled by a cooling fluid, in this case oil.

According to the invention the cooling arrangement 1 comprises a first cooling fluid ring 8, here in the form of an oil ring. The first cooling fluid ring 8 is axially at its end arranged on a stator yoke 3 and is designed to convey fluid, in particular to convey oil.

The arrangement of the first cooling fluid ring 8 on the stator yoke 3 is produced in particular by adhesive bonding with an adhesive. In that way a bonded connection can be achieved.

Furthermore, opposite the stator yoke 3 a second cooling fluid ring 9 is arranged. In this case the first cooling fluid ring 8 can be arranged on a non-connection side and the second cooling fluid ring 9 on a connection side of the winding.

The first cooling fluid ring 8, together with the housing 10, form a first annular space for conveying the oil.

The second cooling fluid ring 9 forms a second annular space for conveying the oil.

FIG. 2 shows the first cooling fluid ring 8 in detail.

In this case, the first cooling fluid ring 8 comprises on the stator side a first annular groove 11 with a first diameter, which with the housing 10 forms a first annular chamber 12. In this case the first annular groove 11 can have annular groove walls (sidewalls of the annular groove) of different heights. Thus, on the stator side there is a first annular groove wall 13 and opposite it a third annular groove wall 14, wherein the first annular groove wall 13 is higher than the third annular groove wall 14.

Close to that there is arranged a second annular groove 16 on the first annular groove 11. The second annular groove 16 has a second, smaller diameter than the first diameter of the first annular groove 11 so that, accordingly, the first annular groove 11 and the second annular groove 16 form a descending step.

In this case, opposite the third annular groove wall 14 a second annular groove wall 21 is provided on the housing side.

The second annular groove 16, with the housing 10, the second annular groove wall 21 on the housing side and the third annular groove wall 14, form a second annular chamber 24 for conveying oil.

The third annular groove wall 14 is arranged between the first annular chamber 12 and the second annular chamber 24 and can, accordingly, be associated with both of them as an annular groove wall.

The first annular chamber 12 is sealed relative to the stator 2 by a first all-round sealing lip 19. The first sealing lip 19 can be arranged at or on the first annular groove wall 13.

The first annular chamber 12 and the second annular chamber 24 are sealed relative to one another by a third all-round sealing lip 20. The third sealing lip 20 is arranged at or on the third annular groove wall 14 and seals the second annular chamber 24 relative to the first annular chamber 12.

On the second annular groove wall 21 a second all-round sealing lip 23 is provided, which seals the second annular chamber 24 relative to the housing 10. The second sealing lip 23 is arranged at or on the second annular groove wall 21.

In this case the first sealing lip 19 has a larger radial length (height) than the radial distance between the first annular groove wall 13 and the housing 10. The second sealing lip 23 has a longer radial length (height) than the radial distance between the second annular groove wall 21 and the housing 10.

The third sealing lip 20 (between the first annular chamber 12 and the second annular chamber 24) has a longer radial length (height) than the radial distance between the third annular groove wall 14 and the housing 10.

By virtue of the longer radial lengths of the sealing lips 19, 20, 23, during assembly the whole of the first cooling fluid ring 8 is pushed as a unit into the housing 10, whereby the seals 19, 20, 23 press against the housing 10 and so form a seal. Due to this pressing, a pressure-activated sealing action relative to the housing 10 is produced and the sealing effect is increased. Thanks to the integral design, the “pushing in” of the entire first cooling fluid ring 8 into the housing 10 during assembly can be carried out particularly simply. Alternatively, however, the first sealing lip 19 can be designed to be fitted later.

Thus, not all the sealing lips 19, 20, 23 have to be attached before assembly. However, that is advantageous since assembly is then simplified.

The annular grooves 11, 16 can be made integrally, for example by injection-molding.

Moreover, the sealing lips 19, 20, 23 can be sprayed on and the entire first cooling fluid ring 8 can be made as a two-component injection-molding and therefore integrally. This design is particularly simple to produce.

Alternatively, all or some of the sealing lips 19, 20, 23 can be arranged, for example, by press fitting onto the annular groove walls 13, 14, 21, or they can be bonded on.

Furthermore, the radial length and thickness of the all-round sealing lips 19, 20, 23 are of a size such that radial and axial production tolerances can be compensated.

The radial length and thickness of the all-round sealing lips 19, 20, 23 are also of a size such that radial and axial thermal expansions can be compensated.

This differs according to the size/width of the first cooling fluid ring 8 and can be adapted particularly simply in the case of the integral design with injection-molded sealing lips 19, 20, 23.

By virtue of the annular grooves 11, 16 and their different diameters, the first annular chamber 12 has a first diameter which is larger than the second diameter of the second annular chamber 24.

The first annular chamber 12 also has an oil inlet 25 as the inlet for the cooling fluid, which lets oil into the first annular chamber 12. This inlet can be in the form of a bore in the housing 10.

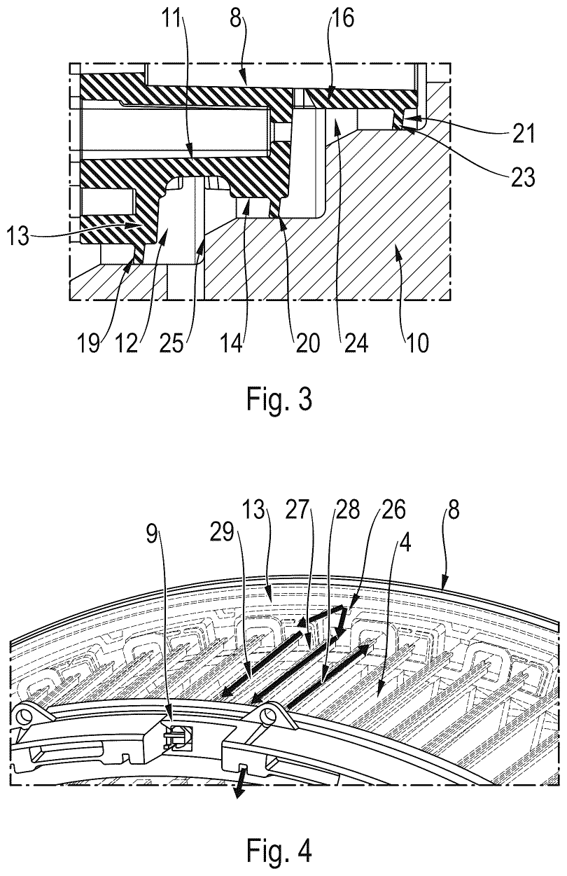

FIG. 3 shows such an oil inlet in detail.

Furthermore, the cooling arrangement according to the invention has a plurality of stator axial ducts. The stator axial ducts extend from the first cooling fluid ring 8 to the second cooling fluid ring 9 and are designed to convey oil between the first cooling fluid ring 8 or the first annular space and the second cooling fluid ring 9, in this case the second annular space.

FIG. 4 shows the stator axial ducts in detail.

First stator axial ducts 27 extend between the first cooling fluid ring 8 and the second cooling fluid ring 9 for transporting oil from the first annular space to the second annular space.

The second cooling fluid ring 9 comprises deflection ducts integrated in or on the second cooling fluid ring 9. In this case, the first stator axial ducts 27 are arranged so that these first stator axial ducts 27 open into the deflection ducts. The deflection ducts deflect the oil flowing through from the first stator axial ducts 27. The deflection ducts are arranged and designed so that they open into second stator axial ducts 28. The second stator axial ducts 28 are in each case arranged adjacent to the first stator axial ducts 27 in the stator 2, in particular in the stator yoke 3.

Moreover, alternately to the pairs of first stator axial ducts 27 and second axial ducts 28, third stator axial ducts 29 are provided, which convey oil from the first annular chamber 12 to the second cooling fluid ring 9, i.e., into the second annular space. These do not lead—as do the first stator axial ducts 27—into the deflection ducts, but directly into the second annular space.

The first stator axial ducts 27, the second stator axial ducts 28, and the third stator axial ducts 29 are in each case arranged uniformly over the periphery of the stator yoke 3 in the stator 2.

Furthermore, the first annular chamber 12 has outlets 26 to let out the oil into the stator axial ducts 27, 29, which outlets on the stator side are in the form of perforations in the first annular groove wall 13. The outlets 26 can be arranged radially above the stator axial ducts 27, 29, for example in such manner that an outlet supplies a first stator axial duct 27 and a third stator axial duct 29.

The oil flowing from the first annular chamber 12 through the first stator axial ducts 27 to the second annular space flows back by way of the deflection ducts 30 into the second stator axial ducts 28 and through the second stator axial ducts 28 as a backwash fluid. In that way effective cooling of the stator 2 is achieved.

The oil flows from the first annular chamber 12 through the third stator axial ducts 29 into the second cooling fluid ring 9, i.e., it flows into the second annular space.

In this case, the total number of stator axial ducts 27, 28, 29 preferably corresponds to the number of stator grooves 4 in which the winding is arranged. Moreover, the second annular chamber 24 has axial inlets 15 in the direction of the stator 2, which are arranged for example in the third annular groove wall 14.

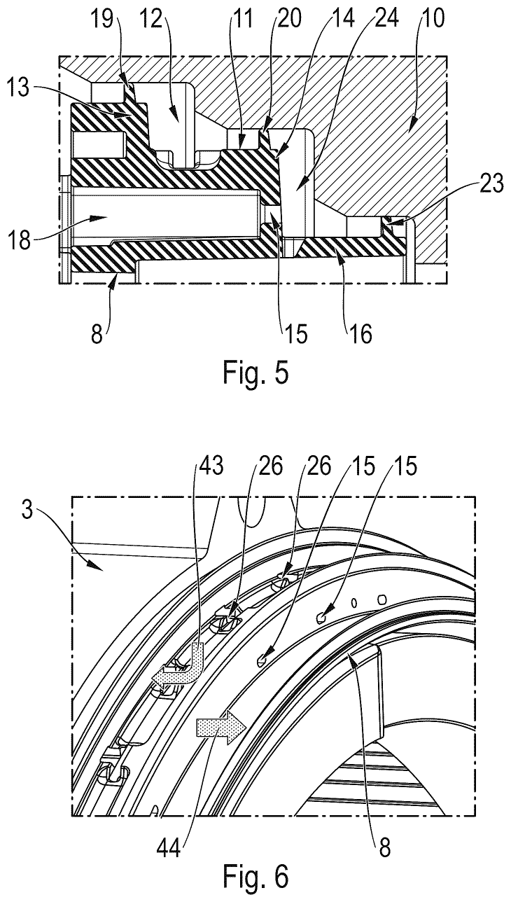

FIG. 5 shows such axial inlets 15 in detail.

Furthermore, axial perforations 18 are provided in the radial direction in the cooling fluid ring 8 under the first annular chamber 12, which open into the axial inlets 15 and thence into the second annular chamber 24. This is possible because the second diameter is smaller than the first diameter so that the second annular chamber 24 is positioned radially lower (with the smaller diameter) than the first annular chamber 12.

Moreover, the first stator axial ducts 27, the second stator axial ducts 28, and the third stator axial ducts 29 are distributed uniformly around a stator periphery, so that one-third of the oil flows into the second annular space and two-thirds flow back into the first annular space as a backwash fluid.

FIG. 6 shows such axial perforations 18 and the inlets 15 in operation.

In this case, the axial perforations 18 are arranged under the first annular chamber 12 in the first cooling fluid ring 8 in such manner that the second stator axial ducts 28 open into the latter. Thus, the oil flowing out of the first annular chamber 12 through the outlets 26 partially flows through the first stator axial ducts 27 (arrow 43), and via the deflection ducts 30, through the first stator axial ducts 27 as a backwash fluid into the axial perforations 18 and through the axial inlets 15 into the second annular chamber 24 (arrow 44). Thus, the first annular chamber 12 and the second annular chamber 24 are fluidically connected to one another by way of the stator 2.

In addition, the second annular chamber 24 has a slot 22a (FIG. 1) for letting out the backwash fluid toward the first winding head 5.

Moreover, two adjacent slots 22b, 22c (FIG. 1) can be provided for letting out the backwash fluid toward the first winding head 5. In this case, the first radial slot 22a can be arranged in the area of a 12 o'clock position, the second slot 22b (FIG. 4) in the area of a 10 o'clock position, and the third slot 22c (FIG. 1) in the area of a 2 o'clock position in the first annular groove 11. In that way the first winding head 5 is cooled by oil drizzling down. Furthermore, screens 7 can be arranged above the third stator axial ducts 29 on the first annular groove wall 13, by means of which the oil flowing into the first stator axial ducts 27 can be adjusted.

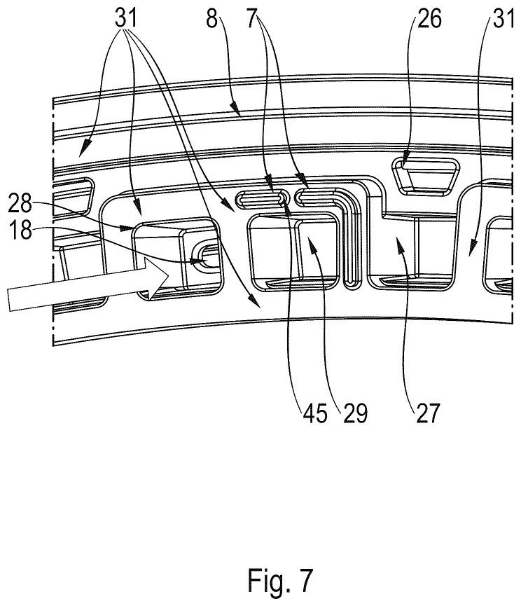

FIG. 7 shows such a screen in detail.

In this case, the screens 7 can be arranged above the third stator axial ducts 29 on the first annular groove wall 13, so that cooling fluid flowing though a corresponding outlet 26 flows between the screens 7 and accordingly the screens 7 act as a volume flow barrier.

An outlet 26 can, for example, supply a third (through-going) stator axial duct 29 and a first stator axial duct 27, since it is positioned above the two stator axial ducts 27, 29. The screen 7 can be in the form of a bulge formed in the axial direction, which is arranged above a third stator axial duct 29 with a through-going hole 45, and also a bulge between a respective first stator axial duct 27 and a third stator axial duct 29. The screen 7 can for example be made integrally with the first cooling fluid ring 8.

Thereafter, the first cooling fluid ring 8 can be bonded by way of bonding surfaces 31 to the stator yoke 3, for fixing it to the stator yoke 3 as well as for conveying the oil. The bonding surfaces 31 are made such that the oil flows from the outlets 26 into the two stator axial ducts 27, 29.

By virtue of the fixing and the screens 7, the volume flow of the first stator axial ducts 27 and the third stator axial ducts 29 can be influenced in such manner that the oil spray quantity on the connection side (second cooling fluid ring 9) and on the non-connection side (first cooling fluid ring) can be adjusted.

The screens 7 can also be arranged only above half of the third stator axial ducts 29.

Likewise, the second annular space can have radial slots (not shown) for letting out the oil flowing through the third stator axial ducts 29 into the second annular space in the direction toward the second winding head 6. For this, likewise a number and in particular three radial slots can be provided, which are arranged in the area of a 12 o'clock position, a 10 o'clock position, and a 2 o'clock position. In that way both of the winding heads 5 and 6 are cooled.

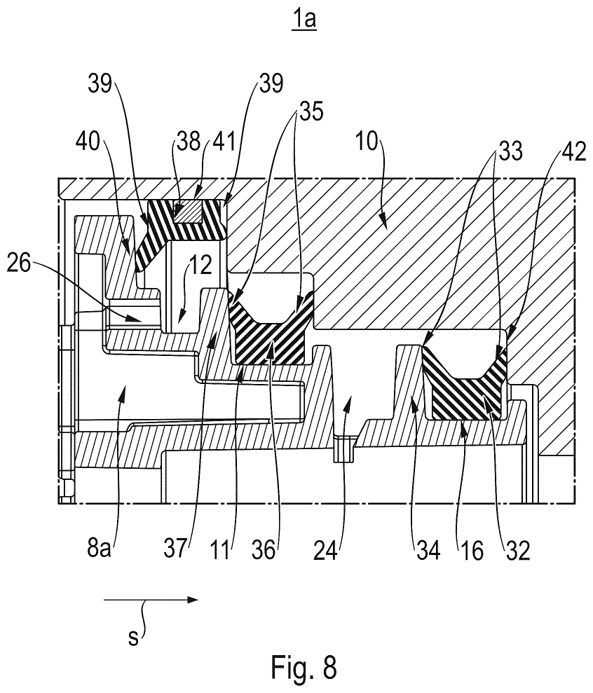

FIG. 8 shows a second design of a further cooling arrangement 1a with a further cooling fluid ring 8a.

The cooling arrangement 1a also comprises the stator 2, which is arranged in the housing 10 to rotate about a rotation axis Rot (FIG. 5). The stator 2 has a stator yoke 3. The stator 2 has stator grooves 4 with a winding, and winding heads 5, 6 at its ends.

Furthermore, the cooling arrangement 1a comprises the first cooling fluid ring 8a. The first cooling fluid ring 8a is arranged axially at its end on a stator yoke 3 and is designed to convey a fluid, in particular oil. In addition, the second cooling fluid ring 9 is arranged opposite it on the stator yoke 3.

In this case the first cooling fluid ring 8a has on the stator side the first annular groove 11 with the first diameter, which with the housing 10, forms the first annular chamber 12 with the first diameter, and adjacent thereto the second annular groove 16 with the second diameter, which with the housing 10, forms the second annular chamber 24.

To seal the second annular chamber 24 relative to the housing 10, a second all-round seal is provided. This consists of a second seal base 32 with identical axially lateral second sealing tubes 33 projecting in the radial direction. The second seal is inserted with the second seal base 32 into the second annular groove 16. For that, during assembly the seal base 32 is inserted loosely into the second annular groove 16 or press-fitted onto the second annular groove 16. In addition, the second annular groove 16 has lateral contact elements which consist of the annular groove 16 itself, for example a second projection 34, and the housing 10, for example the lateral inside wall 42 of the housing 10.

For assembly, the second seal base 32 is inserted between the second projection 34 and the lateral inside wall 42. During assembly the second sealing tubes 33 are pressed against the projection 34 and the housing 10 (inside wall 42), so that a pressure-activated sealing action relative to the housing 10 and also to the first annular chamber 12 is produced. An arrow S indicates the thrust direction in which the first cooling fluid ring 8a is pushed with the second all-round seal into the housing 10. After assembly, the second all-round seal is thus pressure-activated relative to the housing 10 and the second projection 34.

Furthermore, to seal the first annular chamber 12 relative to the second annular chamber 24 a third all-round seal is provided. This consists of a third seal base 36 with axially lateral third sealing tubes 35 projecting in the radial direction. The third seal is inserted with the third seal base 36 into the first annular groove 22. For assembly, the third seal base 36 is inserted loosely into the first annular grove 11 or pressed against the said first annular groove 11.

Furthermore, the first annular groove 11 has lateral contact elements which consist of the first annular groove 11 itself, for example, a third projection 37, and the housing 10, such that a recess for the third seal is formed. For assembly the third seal base 36 is inserted between the projection 37 and the housing 10. During assembly the third sealing tubes 35 are pressed against the third projection 37 and the housing 10, so that a seal, and moreover a pressure-activated sealing action relative to the second annular chamber 24, is produced. After assembly, the third all-round seal is therefore brought into contact with the housing 10 and the third projection 37 in a pressure-activated manner.

In addition, to seal the first annular chamber 12 relative to the stator 2 the first seal is provided as an all-round seal, which consists of a first seal base 38 and axially lateral first sealing tubes 39 projecting in the radial direction.

The first seal base 38 is arranged on an inside of the housing 10 essentially radially opposite the first seal base 38. Moreover, the first annular groove 11 has on the stator side a contact wall 40 (for example the first annular groove wall 13) and opposite it a sidewall of the housing 10 as a first contact element.

Following assembly, the first sealing tubes 39 are in contact with the lateral contact wall 40 and the housing 10 in a pressure-activated manner, so that a pressure-activated sealing action relative to the stator 2 is produced.

The length and thickness of the first seal, which consists of the first seal base 38 and the first sealing tubes 39, are such that radial and axial production tolerances and also radial and axial thermal expansions can be compensated.

Moreover, the first seal is supported against the inside of the housing 10.

With all the seals the pressure-activated sealing action is produced by deformation, which in this case is only brought about by contact against the corresponding housing or component walls.

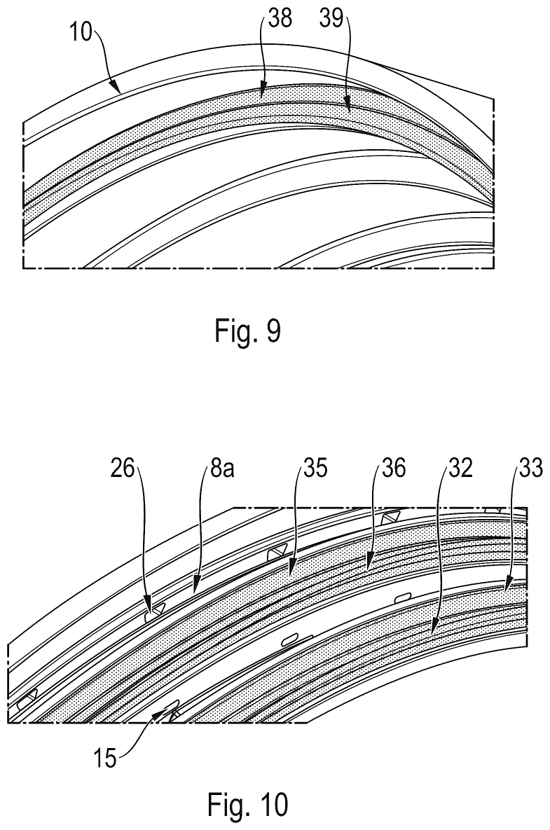

FIG. 9 shows the first seal arranged in the housing 10 with the first seal base 38 and the first sealing tubes 39.

The first seal with the first seal base 38 and the first sealing tubes 39 is designed such that it produces a pressure-activated sealing action relative to the second annular chamber 24 and also a pressure-activated sealing action relative to the stator 2.

Furthermore, for a better seating against the inside of the housing 10 and simplified assembly, the first seal base 38 can have a metal inlay 41.

The first seal can also be pre-fitted in the housing 10.

In this case, the second seal, which consists of the second seal base 32 and the second sealing tubes 33, and also the third seal, which consists of the third seal base 36 and the third sealing tubes 35, are also designed such that they too produce a pressure-activated sealing action relative to the first annular chamber 12 and a pressure-activated sealing action relative to the housing 10. Moreover, the first seal and the second seal have different cylindrical diameters and are of a size such that, by virtue of the length and thickness of the all-round seal, radial and axial production tolerances and radial and axial thermal expansions can be compensated.

FIG. 10 shows the cooling arrangement 1a in operation.

In this case a second seal and a third seal are present, each respectively having a second seal base 32 and second sealing tubes 33 and a third seal base 36 and third sealing tubes 35.

Likewise, outlets 26 are provided, for letting the oil flow out into the first stator axial ducts 27 and the third stator axial ducts 29 described earlier.

Furthermore, the oil flowing from the first annular chamber 12 through the first stator axial ducts 27 to the second annular space flows, by way of the deflecting ducts 30, into the second stator axial ducts 28 and through the second stator axial ducts 28 as a backwash fluid into the axial perforations 18 and through the axial inlets 15 into the second annular chamber 24.

From there, the backwash fluid flows via the slots 22a, 22b and 22c onto the first winding head 5.

### LIST OF INDEXES

1, 1a Cooling arrangement
2 Stator
3 Stator yoke
4 Stator grooves
5 First winding head
6 Second winding head
7 Screens
8, 8a First cooling fluid ring
9 Second cooling fluid ring
10 Housing
11 First annular groove
12 First annular chamber
13 First annular groove wall
14 Third annular groove wall
15 Axial inlets
16 Second annular groove
18 Axial perforations
19 First sealing lip
20 Third sealing lip
21 Second annular groove wall
22a, b, c Slots
23 Second sealing lip
24 Second annular chamber
25 Oil inlet
26 Axial outlets
27 First stator axial ducts
28 Second stator axial ducts
29 Third stator axial ducts
30 Deflection ducts
31 Bonding surfaces
32 Second seal base
33 Second sealing tubes
34 Second projection
35 Third sealing tubes
36 Third seal base
37 Third projection
38 First seal base
39 First sealing tubes
40 Contact wall
41 Metal inlay
42 Lateral inside wall
43 Arrow
44 Arrow
45 Through-hole

1. A cooling arrangement (1, 1a) for cooling a stator (2) of an electric machine, comprising:
a housing (10); and
a stator (2) arranged fixed around a rotation axis in the housing (10), wherein the rotation axis (Rot) defines an axial direction and, radially relative to the rotation axis (Rot), a radial direction;
a first cooling fluid ring (8, 8a) is mounted on a first axial end of the stator to form a first annular space with the housing (10), the first cooling fluid ring configured to convey cooling fluid; and
a second cooling fluid ring (9) mounted on a second axial end of the stator to form a second annular space with the housing, the second cooling fluid ring configured to convey cooling fluid;
wherein:
the first cooling fluid ring (8, 8a) defines on stator side a first annular groove (11) with a first diameter, which with the housing (10) forms a first annular chamber (12);
the first annular chamber (12) defines at least one cooling fluid inlet to let in a cooling fluid;
the first annular chamber (12) is sealed on the stator side by a first all-round seal;
the first annular chamber (12) has outlets (26) to let out the cooling fluid in the stator (2);
the cooling fluid can be deflected at least partially in the stator (2) as a backwash fluid;
the first cooling fluid ring (8, 8a) defines at least one second annular groove (16) with a second diameter smaller than the first diameter and which forms with the housing (10) at least one second annular chamber (24);
the second annular groove (16) is arranged facing away from the stator and axially adjacent to the first annular groove (11);
the second annular chamber (24) has axial inlets (15) in the direction of the stator (2);
the first cooling ring defines axial perforations (18) extending in the axial direction and positioned radially inside of the first annular chamber (12), the axial perforations opening in the axial direction into the axial inlets (15) of the second annular chamber (24) to let in the deflected backwash fluid into the second annular chamber (24); and
a third all-round seal is arranged on the housing (10) between the first annular chamber (12) and the second annular chamber (24), the third all-around seal configured for sealing the first annular chamber (12) relative to the second annular chamber (24).

2. The cooling arrangement (1, 1a) according to claim 1, wherein:
the stator (2) defines first stator axial ducts (27) uniformly distributed around a stator periphery;
the stator defines second stator axial ducts (28) arranged adjacent to the first stator axial ducts (27);
deflection ducts (30) are formed in or on the second annular space in order to deflect the cooling fluid flowing through the first stator axial ducts (27) and the corresponding outlets (26) into the second stator axial ducts (28) as a backwash fluid;
the second stator axial ducts (28) open into the axial perforations (18) so that the backwash fluid can flow through the axial perforations (18) and through the axial inlets (15) into the second annular chamber (24) of the first annular space; and
the stator defines third stator axial ducts (29) adjacent to the second stator axial ducts (28), the third stator axial ducts arranged for conveying the cooling fluid from the first annular space into the second annular space.

3. The cooling arrangement (1, 1a) according to claim 2, wherein the first stator axial ducts (27), second stator axial ducts (28), and third stator axial ducts (29) are distributed uniformly around the stator periphery, so that in use half of the cooling fluid flows into the second annular space and half of the cooling fluid flows back into the second annular chamber (24) of the first annular space as a backwash fluid.

4. The cooling arrangement (1, 1a) according to claim 2, further comprising screens (7) arranged on the first annular groove (11) between the first annular groove (11) and the third stator axial ducts (29), by means of which the cooling fluid flowing into the third stator axial ducts (29) can be adjusted.

5. The cooling arrangement (1, 1a) according to claim 4, wherein the screens (7) are arranged radially outside of the third stator axial ducts (29) on the first annular groove (11), so that in use a cooling fluid flowing through a corresponding outlet (26) flows through the screens (7) and the screens (7) form a volume flow barrier.

6. The cooling arrangement (1, 1a) according to claim 2, wherein the stator (2) has a stator winding, which is fitted into stator grooves (4), and the number of stator axial ducts (27, 28, 29) is equal to the number of stator grooves (4).

7. The cooling arrangement (1, 1a) according to claim 1, wherein the stator (2) has a first winding head (5) arranged at least in part at the first axial end of the stator and positioned radially inside of the first annular space, and a second winding head (6) arranged at least in part at the second axial end of the stator and positioned radially inside of the second annular space, and wherein the second annular groove (16) has at least one first radial slot (22a) configured for letting out the backwash fluid in the direction of the first winding head (5).

8. The cooling arrangement (1, 1a) according to claim 7, rein the at least one first radial slot (22a) includes a first radial slot and two further slots (22b, 22c), wherein the first radial slot (22a) and the two further slots (22b, 22c) are arranged on a radially outer side of the second annular groove (16) and are configured for letting out the backwash fluid in the direction of the first winding head (5).

9. The cooling arrangement (1, 1a) according to claim 8, characterized in that the first radial slot and the two further slots (22 a, b and c) are arranged in the area of a 12 o'clock position and in the area of a 10 o'clock position and in the area of a 2 o'clock position of the second annular groove (16).

10. The cooling arrangement (1, 1a) according to claim 1, wherein the first seal, the second seal, and the third seal are each in the form of all-round sealing lips (19, 20, 23) having a radial length that is greater than a first radial length between the first annular chamber (12) and the housing or a second radial length between the second annular chamber (24) and the housing (10), so that each of the first sealing lip (19), the second sealing lip (23), and the third sealing lip (20) make pressure-activated contact with the housing (10).

11. The cooling arrangement (1, 1a) according to claim 10, wherein the first all-round sealing lip (19) is arranged on a first annular groove wall (13) of the first annular groove (11) of the first annular chamber (12), facing radially in the direction of the housing (10), and wherein the third sealing lip (20) is arranged opposite the first sealing lip (19) on the first annular groove (11) facing radially toward the housing (10), on a second annular groove wall (21).

12. The cooling arrangement (1, 1a) according to claim 1, wherein the first sealing lip (19) is injection-molded onto the first annular groove (11), the second sealing lip (23) is injection-molded onto the first annular groove (11), and the third sealing lip (20) is injection-molded onto the second annular groove (16).

13. The cooling arrangement (1, 1a) according to claim 10, wherein the first annular groove (11) and the second annular groove (16) are made as first components of a two-component injection-molded part and the first sealing lip (19) and the second sealing lip (23) and the third sealing lip (20) are made as the second component of the two-component injection-molded part, so that an integral production of the first cooling ring (8) with the seals is made possible.

14. The cooling arrangement (1, 1a) according to claim 10, wherein the second sealing lip (23) is injection-molded onto the second annular groove (16) and the third sealing lip (20) is injection-molded onto the first annular groove (11).

15. The cooling arrangement (1, 1a) according to claim 1, wherein:
the second all-round seal is formed of a second seal base (32) and second sealing tubes (33) that project from sides of the second seal base;
the second seal with the second seal base (32) is arranged on the second annular groove (16);
the second annular groove (16) has second lateral contact elements which are formed by the second annular groove (16) itself and by the housing (10), and wherein the second sealing tubes (33) are in pressure-activated contact against the second lateral contact elements, so that a pressure-activated sealing action relative to the housing (10) is produced;
the third all-round seal is formed of a third seal base (36) and third sealing tubes (36) that project radially outward from sides of the third seal base, wherein the third seal with the third seal base (36) is arranged on the first annular groove (11);
the first annular groove (11) has lateral third contact elements which are formed by the first annular groove (11) itself and by the housing (10);
the third sealing tubes (36) are in pressure-activated contact with the third lateral contact elements, so that a pressure-activated sealing action relative to the second annular chamber (24) is produced;
the first all-round seal is formed of a first seal base (38) and first sealing tubes (39) that project radially from sides of the first seal base, and wherein the first seal base (38) is arranged on the housing (10); and
the first annular groove (11) has a contact wall (40) on the stator side and the housing (10) has first contact elements and wherein the first sealing tubes (39) make pressure-activated contact with the first contact elements so that a pressure-activated sealing action relative to the stator (2) is produced.

16. The cooling arrangement (1, 1a) according to claim 15, wherein the first all-round seal is pre-fitted into the housing (10) and the first seal base (38) has a metal inlay (41) configured to enhance adhesion of the first seal base to the housing.
